(19) United States
(12) Patent Application Publication
(10) Pub. No.: US 2020/0090561 A1
(43) Pub. Date: Mar. 19, 2020

(54) CONTEXTUAL ADJUSTMENT TO SHADOW BOX IMAGES

(71) Applicant: Font Diner, Inc., Eau Claire, WI (US)

(72) Inventor: Stuart Sandler, Eau Claire, WI (US)

(21) Appl. No.: 16/573,779

(22) Filed: Sep. 17, 2019

Related U.S. Application Data
(60) Provisional application No. 62/765,837, filed on Sep. 17, 2018.
(60) Provisional application No. 62/901,653, filed on Sep. 17, 2019.

(51) Int. Cl. G09F 19/12; G02B 27/22; A47G 1/06

(52) U.S. Cl. CPC G09F 19/12; A47G 1/06; G02B 27/2278

(57) ABSTRACT

Apparatus and associated methods relate to modifying contextual images to portions of an image applied to a layer in a shadow box. In an illustrative example, contextual imagery may adjust a portion of an original complete two-dimensional image deconstructed and applied to any of a plurality of panel substrates. Each of the plurality of panel substrates may be spatially separated into, for example, parallel layers in the shadow box. The adjustment may be made, for example, as a static addition or subtraction to provide visual context. Some examples may include standoff contextual features on one or more of the layers. Various examples may visually enhance a dimensional parallax effect for a viewer from a wide range of viewing angles.

### CROSS-REFERENCE TO RELATED APPLICATIONS

This application claims the benefit of U.S. Provisional Application Ser. No. 62/765,837, titled “Shadow Box Display Case System for Video Game, Film and Animated Cartoon Themes and Graphics,” filed by Sandler, Stuart on Sep. 17, 2018, and U.S. Provisional Application Ser. No. 62/901,653, titled “Shadow Box Display,” filed by Sandler, Stuart on Sep. 17, 2019.

This application incorporates the entire contents of the foregoing applications herein by reference.

### TECHNICAL FIELD

Various embodiments relate generally to parallax viewed images in a multi-layer shadowbox.

### SUMMARY

Apparatus and associated methods relate to modifying contextual images to portions of an image applied to a layer in a shadow box. In an illustrative example, contextual imagery may adjust a portion of an original complete two dimensional image deconstructed and applied to any of a plurality of panel substrates. Each of the plurality of panel substrates may be spatially separated into, for example, parallel layers in the shadow box. The adjustment may be made, for example, as a static addition or subtraction to provide visual context. Some examples may include standoff contextual features on one or more of the layers. Various examples may visually enhance a dimensional parallax effect for a viewer from a wide range of viewing angles.

Various embodiments may achieve one or more advantages. For example, some embodiments may enhance a dimensional parallax effect for a viewer.

The details of various embodiments are set forth in the accompanying drawings and the description below. Other features and advantages will be apparent from the description and drawings, and from the claims.

### DETAILED DESCRIPTION OF ILLUSTRATIVE EMBODIMENTS

Various embodiments may include processes and methods for the deconstruction of existing artwork and re-synthesis via layering of the deconstructed images on panel substrates with the addition or subtraction of standoff contextual features to one or more of the panel substrates to create a dimensional parallax effect for a viewer.

Some implementations may include a method of manufacturing wherein each panel substrate displays a portion of a complete image that may be artistically adjusted with the addition or subtraction of standoff contextual features on the different layers to enhance a dimensional parallax effect for a viewer.

In various examples, the original complete image may be one or more two dimensional images. Examples of embodiments with one or more two or three dimensional images are described, for example, at least with reference to [0003] of U.S. Provisional Application Ser. No. 62/765,837, titled “Shadow Box Display Case System for Video Game, Film and Animated Cartoon Themes and Graphics,” filed by Sandler, Stuart on Sep. 17, 2018, the entire contents of which is hereby incorporated by reference. Further exemplary embodiments are described at least with reference to FIGS. 6-7, for example, of U.S. Provisional Application Ser. No. 62/901,653, titled “Shadow Box Display,” filed by Sandler, Stuart on Sep. 17, 2019, the entire contents of which is hereby incorporated by reference.

In one exemplary aspect, a method of manufacturing a shadow box may include providing a housing formed of laterally opposing side walls, opposing top and bottom walls, and a back wall that extends between the side walls to define a viewing chamber and extracting a first plurality of images from a first source image. The method may include receiving the first plurality of extracted images, optionally, and also providing a plurality of transparent substrates. For each of the plurality of substrates, the method may include providing a corresponding mounting receiver to support the substrate layer in the viewing chamber. The method may include spatially distributing the first plurality of images onto at least two of the plurality of substrate layers by displacing each of the received images to register with one of the plurality of substrates (e.g., by printing, mounting, or otherwise establishing an image to the substrate, wherein the image may be visually perceptible as a two or three dimensional image or object, respectively). The method may further include selecting at least one of the substrate layers to modify with visually perceptible contextual information; and modifying the selected substrate layer to provide the visually perceptible contextual information.

In some embodiments of the method, the visually perceptible contextual information may include artistic elements viewable from predetermined viewing angles. Modifying the selected substrate layer to provide the visually perceptible contextual information may further include adding and/or removing contextual visual information to or from the image, or modifying at least one of the received images associated with a substrate layer that is within the viewing chamber and between the back wall and a front-most layer that is farthest from the back wall.

In some examples, the modified image may include visually perceptible contextual information viewable from a range of viewing angles. By way of example and not limitation, the viewing angles may be between about 10 degrees to about 80 degrees, about 20 degrees to about 70 degrees, about 30 degrees to about 60 degrees, or about 40 degrees to about 50 degrees.

The back wall further may include an opaque substrate. The first source image may be a two dimensional image.

The method may further include extracting at least one second image from a second source image that is different than the first source image, and spatially distributing the at least one second image onto at least one of the plurality of substrate layers by displacing each of the at least one second image to register with a corresponding one of the plurality of substrates. The method may further include positioning each of the at least one second images at a user-defined location with respect to the corresponding one of the plurality of substrates. Each of the plurality of substrates may have a uniform thickness between opposing major surfaces. For each of the plurality of substrates, each of the corresponding opposing major surfaces may lie in parallel planes. Providing a corresponding mounting receiver further may further include, for each of the plurality of substrates, providing a corresponding mounting receiver formed with the housing to support the corresponding substrate in a corresponding one of a plurality of planes that are parallel to each other and spaced apart in a direction orthogonal to the major surfaces. In some embodiments, each of the mounting receivers may include a slot formed in the housing.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A method of manufacturing a shadow box, the method comprising:
providing a housing formed of laterally opposing side walls, opposing top and bottom walls, and a back wall that extends between the side walls to define a viewing chamber;
extracting a first plurality of images from a first source image;
receiving the first plurality of extracted images;
providing a plurality of transparent substrates;
for each of the plurality of substrates, providing a corresponding mounting receiver to support the substrate layer in the viewing chamber;
spatially distributing the first plurality of images onto at least two of the plurality of substrate layers by displacing each of the received images to register with one of the plurality of substrates;
selecting at least one of the substrate layers to modify with visually perceptible contextual information;
modifying the selected substrate layer to provide the visually perceptible contextual information.

2. The method of claim 1, wherein the visually perceptible contextual information comprises artistic elements viewable from predetermined viewing angles.

3. The method of claim 1, wherein the modifying the selected substrate layer to provide the visually perceptible contextual information further comprises adding contextual visual information to the image.

4. The method of claim 1, wherein the modifying the selected substrate layer to provide the visually perceptible contextual information further comprises removing contextual visual information from the image

5. The method of claim 1, wherein the modifying the selected substrate layer to provide the visually perceptible contextual information further comprises modifying at least one of the received images associated with a substrate layer that is within the viewing chamber and between the back wall and a front-most layer that is farthest from the back wall.

6. The method of claim 1, wherein the modified image comprises visually perceptible contextual information viewable from a range of viewing angles.

7. The method of claim 6, wherein the viewing angle is between about 10 degrees to about 80 degrees.

8. The method of claim 6, wherein the viewing angle is between about 20 degrees to about 70 degrees.

9. The method of claim 6, wherein the viewing angle is between about 30 degrees to about 60 degrees.

10. The method of claim 6, wherein the viewing angle is between about 40 degrees to about 50 degrees.

11. The method of claim 1, wherein the back wall further comprising an opaque substrate.

12. The method of claim 1, wherein the first source image is a two dimensional image.

13. The method of claim 1, further comprising extracting at least one second image from a second source image that is different than the first source image.

14. The method of claim 13, further comprising spatially distributing the at least one second image onto at least one of the plurality of substrate layers by displacing each of the at least one second image to register with a corresponding one of the plurality of substrates.

15. The method of claim 13, further comprising positioning each of the at least one second images at a user-defined location with respect to the corresponding one of the plurality of substrates.

16. The method of claim 1, wherein each of the plurality of substrates has a uniform thickness between opposing major surfaces.

17. The method of claim 16, wherein for each of the plurality of substrates, each of the corresponding opposing major surfaces lie in parallel planes.

18. The method of claim 16, providing a corresponding mounting receiver further comprises or each of the plurality of substrates, providing a corresponding mounting receiver formed with the housing to support the corresponding substrate in a corresponding one of a plurality of planes that are parallel to each other and spaced apart in a direction orthogonal to the major surfaces.

19. The method of claim 1, wherein each of the mounting receivers comprises a slot formed in the housing.

20. An apparatus formed by a method of manufacturing a shadow box, the method comprising:
providing a housing formed of laterally opposing side walls, opposing top and bottom walls, and a back wall that extends between the side walls to define a viewing chamber;
extracting a first plurality of images from a first source image;
receiving the first plurality of extracted images;
providing a plurality of transparent substrates;
for each of the plurality of substrates, providing a corresponding mounting receiver to support the substrate layer in the viewing chamber;
spatially distributing the first plurality of images onto at least two of the plurality of substrate layers by displacing each of the received images to register with one of the plurality of substrates;
selecting at least one of the substrate layers to modify with visually perceptible contextual information;
modifying the selected substrate layer to provide the visually perceptible contextual information.
